(19) United States
(12) Patent Application Publication
(10) Pub. No.: US 2011/0036961 A1
(43) Pub. Date: Feb. 17, 2011

(54) Modular Apparatus and Assembly

(75) Inventors: Michael Chowaniec, Chemnitz (DE); Klaus Rohne, Lichtenstein (DE); Dietmar Schwabe, Neumark (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/853,093

(22) Filed: Aug. 9, 2010

(30) Foreign Application Priority Data
Aug. 11, 2009 (EP) EP 09167617

(51) Int. Cl. F16M 13/00

(52) U.S. Cl. 248/309.1

(57) ABSTRACT

A modular apparatus comprising a mounting rail, a first assembly and a second assembly, wherein the assemblies are arranged on the mounting rail which has a profile configured for attaching the assemblies to a rear wall associated with the assemblies. A space is formed between the rear wall and the mounting rail, and the first assembly is configured to produce an overpressure in the space. In addition, the second assembly is configured such that the overpressure results in a medium, which is located in the space, flowing into the interior of the second assembly, for cooling assemblies.

### BACKGROUND OF THE INVENTION

1. Field of the Invention

The invention relates to modular assemblies and, more particularly, to a modular apparatus comprising a mounting rail, a first assembly and a second assembly, where the assemblies are arranged on the mounting rail and the mounting rail has a profile which is configured to attach the assemblies to a rear wall associated with the assemblies.

The invention also relates to an assembly for mounting on a mounting rail, comprising a housing, where the housing is configured to be attached to the mounting rail.

2. Description of the Related Art

EP 0 740 499 A1, DE 10 2004 056 243 A1, U.S. Pat. No. 4,829,402 A1, DE 32 02 271 A1 and DE 35 09 908 A1 each disclose an apparatus which can be constructed in modular form, where each apparatus comprises a plurality of assemblies which are attached to a mounting rail, such as a profiled rail composed of metal, i.e., a top-hat profile rail.

DE 10 2004 056 243 A1 discloses an apparatus which is designed to form a modular automation system and to provide an optimized arrangement of assemblies and automation components. The other references, EP 0 740 499, DE 10 2004 056 243A1, U.S. Pat. No. 4,829,402 A1, DE 32 02 271 A1 and DE 35 09 908 A1 disclose cooling apparatuses, apparatuses for dissipating heat losses and attachment of assemblies to a top-hat profile rail, with regard to a connection to a heat sink.

When designing assemblies which can be arranged in a row in a modular form, preferably for constructing an automation appliance for automation of an industrial process, a person performing the activation or a fitter is faced with the problem of dissipating the heat losses created by the electrical assemblies. To this end, DE 32 02 271 A1 proposes that the assemblies be attached to a mounting rail, where the mounting rail has a closed metallic hollow profile comprising a heat pipe. EP 0 740 499 A1 provides a heat-sink connection to the top-hat profile rail as a proposed solution. In DE 35 09 908 A1, a cooling pipe is arranged in a mounting rack such that the cooling pipe can be connected to an apparatus which has cooling nozzles, with the cooling nozzles being aligned with heat nests.

The above-described prior art documents have the disadvantage in that the disclosed apparatuses have a complex design.

### SUMMARY OF THE INVENTION

It is therefore an object of the invention to provide a modular apparatus in which the assemblies are actively cooled such that design complexity is kept as low as possible.

This and other objects and advantages are achieved in accordance with the invention by providing a modular apparatus in which a space is formed between the rear wall and the mounting rail and the first assembly is configured to produce an overpressure in the space, where the second assembly is configured such that the overpressure results in a medium, which is located in the space, flowing into the interior of the second assembly, for cooling the assemblies. The rear walls of the assemblies are accordingly configured such that a cooling medium, such as air, can flow into the space formed by the cover of the assembly onto a channel in the mounting rail, and can flow out of the channel. If, for example, a top-hat profile rail with a U-shaped or hat-like profile is used as the mounting rail, then the U-shaped profile provides a basis for a subsequent flow channel. A flow channel is formed by covering the U-profile with the rear walls of the assemblies. Two types of assemblies are preferably then provided for constructing a modular apparatus from individual assemblies, where a first type of assembly comprises an active cooling assembly and, for example, as the device for producing an overpressure, includes a radial fan or a synthetic jet drive. Alternatively, the assembly can have a compressed-air connection, to which a compressed-air hose could then be connected, as is already present in most cases in an industrial environment. In alternative embodiments, the assembly is provided with a pressure reducer depending on the cooling requirements or an amount of air flowing through the mounting rail.

The second type of assemblies generally comprise assemblies that produce electrical heat losses. The overpressure produced by the cooling assemblies allows the medium, for example air, to flow into the flow channel, and is passed on through the flow channel to the assemblies. The rear walls of the assemblies of this embodiment are configured to pass the air flow that is produced into the interior of an assembly. The mutual interaction of the mounting rail and appropriately configured rear walls of the assemblies therefore provides a ventilation channel, which is used to cool the assemblies, in a simple manner.

In an embodiment of the invention, the assemblies are configured such that the arrangement of assemblies in a row on the mounting rail forms a flow channel for the medium. This flow channel then extends from a start of the modular system to an end of the modular system. In essence, the flow channel is parallel to a longitudinally extending axis of symmetry of the mounting rail.

It is expedient for the assemblies to have a housing with a passage for the medium in the rear wall.

It is also advantageous for a sealing element to be arranged between the mounting rail and the assembly. This sealing element may, for example, be arranged as a sealing plug at the start of the modular apparatus between the mounting rail and the first assembly such that the cavity formed by the U-profile and the rear wall is sealed. It is likewise worthwhile to also arrange a sealing plug at the end of the modular apparatus formed from the individual assemblies. The flow channel then extends from one sealing plug to the other sealing plug.

It is also advantageous for the mounting rail to be fitted to a wall, for example, by attachment elements, where a further sealing element is arranged between an attachment element, which passes through the mounting rail for attachment to the wall and the mounting rail.

Further passage openings are arranged in the housing for the medium to flow through the assembly to optimize cooling performance. The assemblies preferably have a plurality of air inlet openings for this purpose.

The object of the invention is also achieved by an assembly for mounting on a mounting rail, comprising a housing configured to be attached to the mounting rail, where a rear wall of the housing has a passage which is directed to the mounting rail. In this type of assembly, it is advantageous to be able to provide the assembly with a standard housing which, as an advantageous embodiment, has the passage on its rear wall. By way of example, this standard housing can be used to construct an active cooling assembly in which a device for producing an overpressure is integrated in the housing. The device, such a radial fan, ensures that, for example, air flows through the passage into the U-profile of the mounting rail

However, the same housing can also be used to construct an assembly that uses electrical components and produces heat losses. The flowing air produced by the active cooling assembly can now be passed through the same passage into the assembly that produces the heat losses, thus cooling the assembly.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in more detail below based on the exemplary embodiments illustrated in the figures, in which:

FIG. 1 is a schematic illustration of a modular apparatus in accordance with the invention;

FIG. 2 is a schematic illustration of an assembly, arranged on a mounting rail, with a sealing element in accordance with the invention;

FIG. 3 is a side-view illustration of an assembly, arranged on a mounting rail, with cooling air flows in accordance with the invention; and

FIG. 4 is a side-view illustration of an assembly, arranged on a mounting rail, with waste-heat flows in accordance with the invention.

### DETAILED DESCRIPTION OF THE PREFERRED EMBODIMENTS

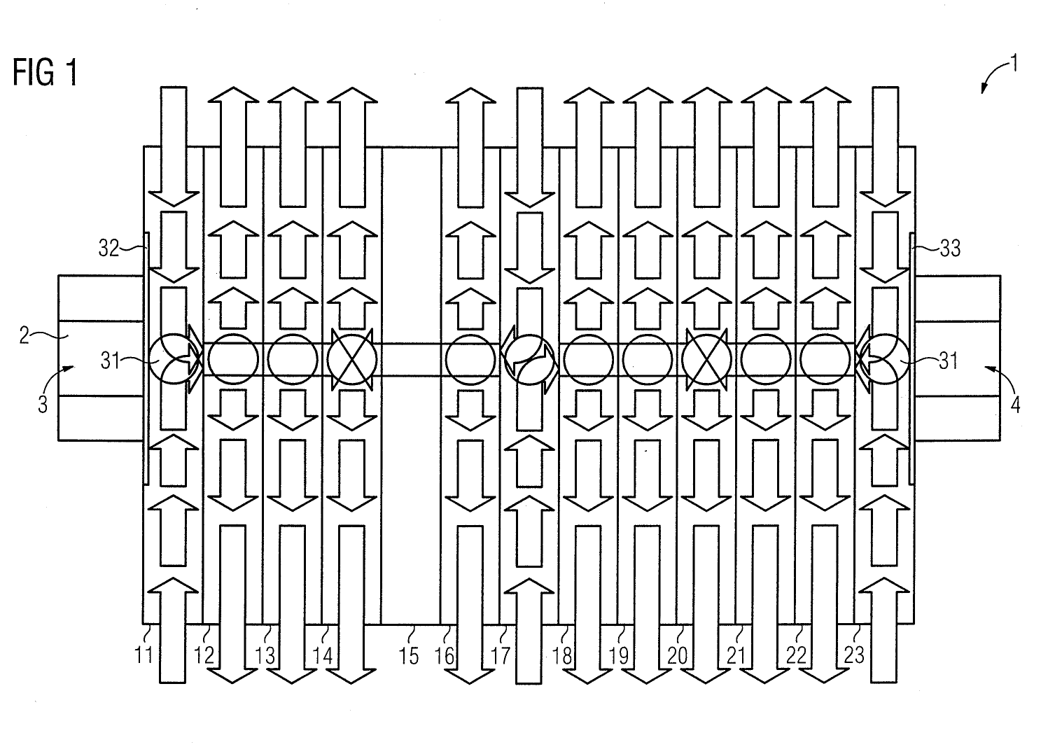

With reference to FIG. 1, shown therein is a modular apparatus 1 that comprises a mounting rail 2, a first assembly 11 and a second assembly 12, with the assemblies 11, 12 being arranged on the mounting rail 2, and with the mounting rail 2 having a profile, which is configured to attach the assemblies 11, 12 to a rear wall 11a, 12a associated with the assemblies 11, 12 (see FIG. 3 and FIG. 4).

The modular apparatus 1 is an automation system with individual automation components forming individual assemblies. Seen from left to right in the FIG. 1, and from a start 3 to an end 4, the automation system is formed from thirteen individual assemblies 11, . . . , 23. The configuration begins at the start 3 with the first assembly 11, and finishes with the thirteenth assembly 23 at the end 4. Generally, the configuration comprises two fundamental types of assemblies, i.e., an active cooling assembly and a standard assembly, which must be cooled.

Here, the first assembly 11, the seventh assembly 17 and the thirteenth assembly 23 are active cooling assemblies. These assemblies have a device for producing an overpressure.

The other assemblies 12, 13, 14, 16, 18, 19, 20, 21 and 22 are standard assemblies, which produce heat losses that are dissipated by airflows produced by the cooling assemblies. The airflows are indicated symbolically by arrows in FIG. 1. The first assembly 11 is a cooling assembly. Here, the first assembly 11 draws air in from the outside and forces this cooling air through a passage 31 into the space between the assembly rear wall and the profile of the mounting rail 2. The cooling air produced for cooling the assemblies can flow out again from the second, third and fourth assemblies 12, 13, 14. The fifth assembly 15 is an assembly which does not require cooling. The rear wall of the fifth assembly 15 is configured such that the fifth assembly 15 does not impede air flowing through the U-profile. The fifth assembly 15 accordingly has no passage in its rear wall, and nor can cooling air therefore flow into the fifth assembly 15. The assemblies 19 to 22 are framed by the seventh assembly 17 and the thirteenth assembly 23. The seventh assembly 17 is an active cooling assembly and the thirteenth assembly 23 is also an active cooling assembly. Consequently, an airflow is forced to flow through the assemblies 19 to 22 from both sides and can flow out again through the assemblies, as indicated by the arrows.

The arrangement of the assemblies 11 to 23 in a row includes a sealing element 32 at the start 3. The end 4 of the arrangement of the assemblies in a row is also closed by a further, second sealing element 33. The first sealing element 32 and the second sealing element 33 therefore prevent the cooling air produced by the active cooling assemblies from flowing out in an undesired manner.

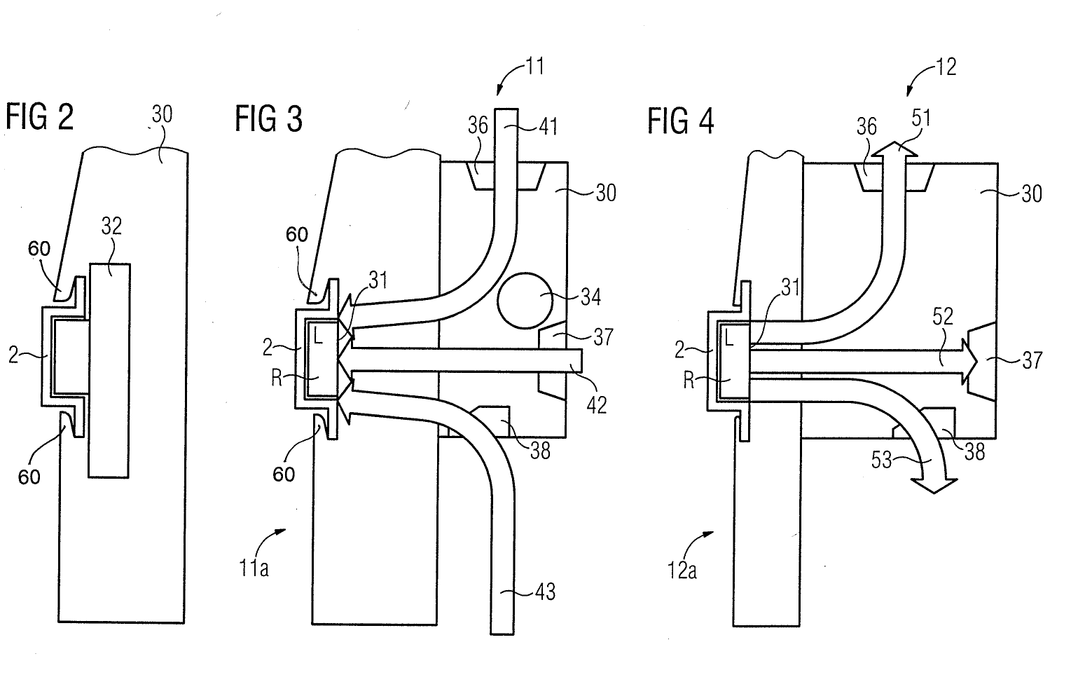

FIG. 2 is a schematic illustration of a side view of an assembly on a mounting rail 2. The assembly includes a housing 30, and the rear wall of the housing is configured such that latching tabs 60 are arranged on the rear wall to mount the assembly on the mounting rail 2. In order to seal the space or flow channel formed by the rear wall of the assembly and the U-shaped profile of the mounting rail, the first sealing element 32 is shaped such that it fits accurately into the U-shaped profile of the mounting rail 2 and seals the side rear-wall boundary of the assembly such that cooling air can no longer flow out of the assembly at this location.

FIG. 3 is a schematic side view illustration of the first assembly 11. Here, the first assembly 11 is again shown arranged on a mounting rail 2 with the aid of latching tabs 60, which are provided on the housing 30. A portion of the first rear wall 11a together with the U-shaped profile of the mounting rail 2 forms a space R into which a first cooling airflow 41, a second cooling airflow 42 and a third cooling airflow 43 can flow. The cooling airflows 41, 42, 43 are created by a device 34 for producing an overpressure that creates a medium L, which is located in the space R into which the first cooling airflow 41, the second cooling airflow 42 and the third cooling airflow 43 flow. By way of example, the device 34 comprises a radial fan that is arranged within the housing 30. In order to allow the cooling airflows 41, 42, 43 to flow, a first passage opening 36, a second passage opening 37 and a third passage opening 38 are arranged in the housing 30.

Analogously to FIG. 3, FIG. 4 shows the second assembly 12 with a second rear wall 12a. The housings 30 for the first assembly 11 as shown in FIG. 3 and for the second assembly 12 as shown in FIG. 4 are identical. A difference between the first assembly 11 and the second assembly 12 is that there is no device for producing an overpressure in the second assembly 12. In fact, the second assembly 12 is an assembly that produces heat losses because of the electrical equipment located in the interior of the assembly. With reference to FIG. 1, the first assembly 11 is an active cooling assembly and therefore ensures that a cooling airflow 41, 42, 43 (see FIG. 3) is forced into the space R, in which case the cooling airflow can flow into the flow channel, which is formed by the mounting rail 2 and the sum of the rear walls 11a, 12a, to the adjacent second assembly 12, and can flow out through the latter as heated cooling air.

FIG. 4 shows a first waste-heat flow 51, which can flow away through the first passage opening 36. The second waste-heat flow 52 flows through the second passage opening 37, and the third waste-heat flow 53 flows away through the third passage opening 38. The heat is dissipated from the second assembly 12 by the outward flow of the waste-heat flows 51, 52, 53, and the second assembly 12 is thereby cooled.

For assemblies which are preferably latched onto a mounting rail, such as a 35 mm standard top-hat profile rail, as well as other rails which are suitable for forming a flow channel, such as a G-rail, the profile is used as a ventilation channel. Ventilation modules or cooling modules can therefore blow cooling air into the interior of the rail, which is closed by sealing elements at the ends of the cooled sections.

A number of cooling modules to be used can now be varied as required, depending on the cooling requirements of the overall modular configuration of the automation system.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A modular apparatus, comprising:
a mounting rail; and
a first assembly and a second assembly arranged on the mounting rail, each of the first and second assembies having a rear wall;
wherein the mounting rail has a profile which is configured to attach to the rear wall of each of the first and second assemblies;
wherein the rear wall of the each of the first and second assemblies forms a space with the mounting rail, the first assembly being configured to produce an overpressure in the space; and
wherein the second assembly is configured such that the overpressure creates a flow of a medium located in the space into an interior of the second assembly, for cooling the second assembly and other assemblies connected to the psace.

2. The modular apparatus as claimed in claim 1, wherein the first and second assemblies are configured such that an arrangement of the first and second assemblies in a row on the mounting rail forms a flow channel for the medium.

3. The modular apparatus as claimed in claim 1, wherein the each of the first and second assemblies includes a housing having a passage in the respective rear wall of the first and second assembly for the medium to flow.

4. The modular apparatus as claimed in claim 2, wherein the each of the first and second assemblies include a housing having a passage in the respective rear wall of the first and second assemblies for the medium to flow.

5. The modular apparatus as claimed in one of claim 1, further comprising:
a sealing element arranged between the mounting rail and each of the first and second assemblies, respectively.

6. The modular apparatus as claimed in claim 1, further comprising:
a sealing element arranged between an attachment element which passes through the mounting rail for attachment to the respective wall of the first and second assemblies and the mounting rail.

7. The modular apparatus as claimed in claim 3, wherein the housing of the each of the first and second assemblies includes further passage openings allowing the medium to flow through the first and second assemblies.

8. An assembly for mounting on a mounting rail, comprising:
a housing configured to be mechanically attached to the mounting rail; and
a rear wall of the housing including a passage which is directed to the mounting rail when the housing is mechanically attached to the mounting rail.

9. The assembly as claimed in claim 8, further comprising:
a device configured to produce an overpressure, by which a medium is passable through the passage into a space located between the rear wall and the mounting rail.
